(19) United States
(12) Patent Application Publication
(10) Pub. No.: US 2021/0138450 A1
(43) Pub. Date: May 13, 2021

(54) ENVIRONMENT FORMING APPARATUS AND IMAGE-CAPTURING DEVICE FOR ENVIRONMENT FORMING APPARATUS

(71) Applicant: ESPEC CORP., Osaka (JP)

(72) Inventor: MASASHI TERAO, Osaka (JP)

(73) Assignee: ESPEC CORP., Osaka (JP)

(21) Appl. No.: 17/094,927

(22) Filed: Nov. 11, 2020

(30) Foreign Application Priority Data
Nov. 12, 2019 (JP) 2019-204433

(51) Int. Cl. B01L 1/02

(52) U.S. Cl. CPC B01L 1/025; B01L 2300/1844; B01L 2300/06

(57) ABSTRACT

There is provided an image-capturing device for an environment forming apparatus used for the environment forming apparatus. The environment forming apparatus includes an environment forming chamber configured to be adjusted to a predetermined environment, and a through-hole configured to connect the environment forming chamber to an outside. The image-capturing device for the environment forming apparatus includes: a camera; an inner tubular member; an outer tubular member configured to cover the inner tubular member; and an air blower. A first ventilation space is formed by an inside of the inner tubular member, and a second ventilation space is formed between the inner tubular member and the outer tubular member. Air is blown toward the camera by the air blower via one of the first ventilation space and the second ventilation space, and is exhausted via the other of the first ventilation space and the second ventilation space.

### CROSS-REFERENCE TO RELATED APPLICATIONS

This application is based on Japanese Patent Application No. 2019-204433 filed on Nov. 12, 2019, the contents of which are incorporated herein by way of reference.

### BACKGROUND

The present invention relates to an image-capturing device for an environment forming apparatus that is mounted on the environment forming apparatus and that captures an image of an inside of the environment forming apparatus.

An environment test apparatus is known as an example of an environment forming apparatus. The environment test apparatus includes a test chamber (an environment forming chamber), and can artificially create a predetermined environment such as a temperature environment (for example, a high temperature or a low temperature) and a humidity environment (for example, high humidity or low humidity) in the test chamber.

The test chamber of the environment test apparatus is a substantially sealed space and an inside thereof may not be visible.

In a field of the environment test apparatus, there is a demand that an image of a state in the test chamber is captured by a camera and the state in the test chamber is externally monitored, and the image of the state in the test chamber is continuously captured and recorded.

Patent Literature 1 discloses an environment test apparatus in which a camera is inserted into a test chamber. In the environment test apparatus disclosed in Patent Literature 1, an air tube for air supply and an air tube for air exhaust are connected to a case in which a camera is housed, and dry air is supplied into the case.
Patent Literature 1: JP-UM-A-H6-43552

In the environment test apparatus disclosed in Patent Literature 1, since the camera is disposed in the test chamber, an image of a state in the test chamber can be captured.

However, there is a concern that durability of the camera is decreased in the environment test apparatus disclosed in Patent Literature 1.

That is, an inside of the test chamber of the environment test apparatus often becomes a harsh environment such as a high temperature or a low temperature, and the camera disposed in the test chamber is exposed to such a harsh environment. The camera is a precision machine, and a usable temperature range and a usable humidity range thereof are limited. A temperature or the like in the test chamber during an environment test often exceeds a usable temperature range or the like of the camera.

A temperature measure is also taken in the environment test apparatus disclosed in Patent Literature 1. That is, in the environment test apparatus disclosed in Patent Literature 1, as described above, the air tube for air supply and the air tube for air exhaust are connected to the case in which the camera is housed, and the dry air is supplied into the case.

However, according to the structure disclosed in Patent Literature 1, it is possible that fresh air and air after heat exchange are mixed in the case and a periphery of the camera cannot be covered with the fresh air.

Therefore, according to the configuration disclosed in Patent Literature 1, there is a concern that the camera is damaged at an early stage.

### SUMMARY

Paying attention to the problems described above of the related art, it is an object of the present invention to develop an image-capturing device for an environment forming apparatus that has few camera failures and can be used for a long period of time.

According to one aspect of the present invention, there is provided an image-capturing device for an environment forming apparatus used for the environment forming apparatus. The environment forming apparatus includes an environment forming chamber configured to be adjusted to a predetermined environment, and a through-hole configured to connect the environment forming chamber to an outside. The image-capturing device for the environment forming apparatus includes: a camera; an inner tubular member; an outer tubular member configured to cover the inner tubular member; and an air blower. A first ventilation space is formed by an inside of the inner tubular member, and a second ventilation space is formed between the inner tubular member and the outer tubular member. Air is blown toward the camera by the air blower via one of the first ventilation space and the second ventilation space, and is exhausted via the other of the first ventilation space and the second ventilation space.

According to other aspect of the present invention, there is provided an image-capturing device for an environment forming apparatus used for the environment forming apparatus. The environment forming apparatus includes an environment forming chamber configured to be adjusted to a predetermined environment, and a through-hole configured to connect the environment forming chamber to an outside. The image-capturing device for the environment forming apparatus includes: a camera; an inner tubular member; an outer tubular member configured to cover the inner tubular member; and an air blower. A first ventilation space is formed by an inside of the inner tubular member, and a second ventilation space is formed between the inner tubular member and the outer tubular member. The camera is at a position on a tip-end side of the first ventilation space or the second ventilation space, and the air blower is at a position on a base-end side of the first ventilation space or the second ventilation space.

According to other aspect of the present invention, there is provided an image-capturing device for an environment forming apparatus used for the environment forming apparatus. The environment forming apparatus includes an environment forming chamber configured to be adjusted to a predetermined environment, and a through-hole configured to connect the environment forming chamber to an outside. The image-capturing device for the environment forming apparatus includes: a camera; an inner tubular member; and an outer tubular member configured to cover the inner tubular member. A first ventilation space is formed by an inside of the inner tubular member, and a second ventilation space is formed between the inner tubular member and the outer tubular member. Air is blown toward the camera via one of the first ventilation space and the second ventilation space, and is exhausted via the other of the first ventilation space and the second ventilation space.

In the aspects described above, it is desirable that a transparent member is mounted on a tip-end portion of the outer tubular member and the transparent member has a temperature-raising function.

In the aspects described above, it is desirable that illumination is provided at a tip-end portion of the outer tubular member or in the vicinity of the tip-end portion.

In the aspect described above, it is desirable that the illumination is installed in a ring shape with respect to a light-incident portion of the camera.

In the aspects described above, it is desirable that the environment forming apparatus includes a main-body-side engagement portion, the image-capturing device for the environment forming apparatus includes a coupling member, the coupling member includes an opening and an image-capturing-device-side engagement portion, the image-capturing-device-side engagement portion is configured to be engaged with the main-body-side engagement portion, and the outer tubular member and the inner tubular member are inserted into the opening.

An aspect related to the environment forming apparatus includes an environment forming apparatus that includes an environment forming chamber configured to be adjusted to a predetermined environment and a through-hole configured to connect the environment forming chamber to an outside. Any of the image-capturing devices for the environment forming apparatuses described above is mounted in the through-hole.

### BRIEF DESCRIPTION OF DRAWINGS

FIG. 1 is a perspective view of an environment forming apparatus on which an image-capturing device for an environment forming apparatus according to an embodiment of the present invention is mounted.

FIG. 2 is a schematic cross-sectional view of a through-hole portion of the environment forming apparatus of FIG. 1.

FIG. 3 is a perspective view of a tip end portion of the image-capturing device for the environment forming apparatus of FIG. 1, showing a state where a sealing glass is removed so as to observe an inside of a tubular body.

FIG. 4 is a perspective view of the image-capturing device for the environment forming apparatus according to the embodiment of the present invention observed from a rear side.

FIG. 5 is an exploded perspective view of the image-capturing device for the environment forming apparatus of FIG. 4.

FIG. 6 is a perspective view of the through-hole portion showing a procedure for mounting the image-capturing device for the environment forming apparatus on the environment forming apparatus.

FIG. 7 is a perspective view of the through-hole portion showing a step subsequent to FIG. 6.

FIG. 8 is a perspective view of the through-hole portion showing a step subsequent to FIG. 7.

FIG. 9 is a perspective view of the environment forming apparatus before the image-capturing device for the environment forming apparatus is mounted.

FIG. 10 is an illustrative view showing an internal structure of the environment forming apparatus of FIG. 9.

### DESCRIPTION OF EMBODIMENTS

Hereinafter, an embodiment of the present invention will be further described.

First, an environment forming apparatus on which an image-capturing device 1 for the environment forming apparatus is mounted will be briefly described.

The environment forming apparatus is specifically an environment test apparatus and is hereinafter referred to as an environment test apparatus 100. Further, the image-capturing device 1 for the environment forming apparatus may be abbreviated to the image-capturing device 1.

The environment test apparatus (environment forming apparatus) 100 artificially creates, for example, a high-temperature environment, a low-temperature environment, a high-humidity environment, and the like.

The environment test apparatus 100 includes an environment adjustment system as shown in FIG. 10. The environment test apparatus 100 includes a test chamber (environment forming chamber) 3, a cooling device 5, a heater 6, a humidification device 7, and an air blower 8. The test chamber (environment forming chamber) 3 is configured with a part of a heat-insulation vessel formed using a heat-insulation wall 2.

In the environment test apparatus 100, there is an air flow path 10 that communicates with the test chamber 3. An evaporator 11 of the cooling device 5, the heater 6, the humidification device 7, and the air blower 8 are provided in the air flow path 10. Further, a temperature sensor 12 and a humidity sensor 13 are provided on an outlet side of the air flow path 10. In the environment test apparatus 100, the members in the air flow path 10, the temperature sensor 12, and the humidity sensor 13 constitute an air conditioning device 15.

The environment test apparatus 100 creates a desired temperature and humidity environment in the test chamber 3 by the air conditioning device 15.

As shown in FIGS. 9 and 10, the environment test apparatus 100 has a through-hole 101 that communicates the test chamber 3 with an outside. The through-hole 101 is referred to as a cable hole and is a hole through which an electric wire of a sensor or the like is inserted.

In an environment test, a test object 16 is placed in the test chamber 3, and the test object 16 is put in a harsh environment, so that a change thereof is observed.

In the environment test, a sensor 17 may be attached to the test object 16 in order to observe a progress of a change of the test object 16 during the test. For example, a strain gauge for observing a change in an outer shape may be attached, or an electrode for measuring a resistance change may be attached. Alternatively, a temperature sensor may be attached to measure a surface temperature of the test object 16. Further, an electric wire for energizing the test object 16 may be attached.

The through-hole 101 is provided mainly for a purpose of inserting the electric wire as described above. Therefore, when there is no need to insert the electric wire, a lid 102 is mounted on the through-hole 101 as shown in FIG. 9.

In the present embodiment, the through-hole 101 is made of a tubular member 105 as shown in FIGS. 2, 5, 6, and 7, and one end thereof protrudes to an outside of the test chamber 3. An external thread (a main-body-side engagement portion) 106 is formed on a protruding portion 107 of the tubular member 105. Further, the tubular member 105 includes flanges 110 and 111, and the heat-insulation wall 2 of the test chamber 3 is sandwiched by the flanges 110 and 111.

As shown in FIG. 6, an internal thread 109 is formed on the lid 102.

The internal thread 109 of the lid 102 is engaged with the external thread (the main-body-side engagement portion) 106 on an environment test apparatus 100 side, so that the lid 102 is attached to the environment test apparatus 100.

Next, the image-capturing device 1 will be described.

As shown in FIG. 5, the image-capturing device 1 is configured with a tubular body portion 20, an air-blowing unit 21, a cover member 22, and an attachment member 23. In the present embodiment, the tubular body portion 20, the air-blowing unit 21, and the cover member 22 integrally constitute a main body portion 25.

As shown in FIGS. 2 and 3, the tubular body portion 20 includes an outer tubular member 30, an inner tubular member 31, a camera unit 32, and a sealing glass (a transparent member) 33. FIG. 2 conceptually illustrates an internal structure of the image-capturing device 1, and each part is simplified for convenience of the drawing. Further, a part of the attachment member 23 is omitted.

The outer tubular member 30 is a pipe made of a material having a heat resistance and a cold resistance. The outer tubular member 30 may be made of a material having heat insulation properties. Particularly, when the outer tubular member 30 is long, it is desirable that the outer tubular member 30 is made of a material having heat insulation properties.

The outer tubular member 30 has an outer diameter substantially equal to an inner diameter of the through-hole 101 of the environment test apparatus 100, and is a pipe having an outer diameter that can be inserted into the through-hole 101 with almost no gap.

The inner tubular member 31 is a pipe whose outer diameter is fairly smaller than an inner diameter of the outer tubular member 30. A total length of the inner tubular member 31 is smaller than a total length of the outer tubular member 30.

The camera unit 32 is configured with a camera 36, a hood member 37, and an illumination member 38.

The camera 36 is a small-sized digital camera and can capture a moving image and a still image.

The camera 36 includes a light-incident portion 51 and can take in light from the light-incident portion 51 so as to capture an image.

The hood member 37 is a tube having a black inner surface.

As shown in FIG. 3, for example, light-emission elements 50 are arranged in an annular shape in the illumination member 38. The light-emission element 50 is, for example, an LED and is a point light source. In the illumination member 38, a large number of light-emission elements 50 serving as the point light sources are attached to a doughnut-shaped substrate.

The number of the light-emission elements 50 is optional, but is desirably plural. For example, it is recommended that the number of the light-emission elements 50 be 3 or more, and it is desirable that the light-emission elements are arranged in a ring shape at intervals, but only one light source may be used.

The illumination member 38 is not limited to a point light source, and may be a planar light-emission body or a linear light-emission body. A light-emission principle is not limited to that of the LED. The illumination member 38 is not limited to the one made of the light-emission elements 50.

The light-incident portion 51 of the camera 36 and surroundings in front of the light-incident portion 51 are covered by the hood member 37. The hood member 37 concentrically surrounds the light-incident portion 51 of the camera 36.

The illumination member 38 is further outside the hood member 37. The illumination member 38 concentrically surrounds the hood member 37.

The camera unit 32 is formed by integrating the camera 36, the hood member 37, and the illumination member 38, and can be handled as a single component.

A positional relationship among the camera 36, the hood member 37, and the illumination member 38 is important.

The hood member 37 is selected to have an inner diameter and a length that do not allow light of the illumination member 38 to be directly incident on the camera 36 and deviate from a viewing angle of the camera 36.

The sealing glass (the transparent member) 33 is a glass referred to as a heater glass and has a temperature-raising function.

Specifically, the sealing glass (the transparent member) 33 has a film-shaped heater (not shown) attached to a transparent heat-resistant glass, and generates heat by energizing a lead wire 53.

In the tubular body portion 20, the inner tubular member 31 and the camera unit 32 are built in the outer tubular member 30, and the sealing glass (the transparent member) 33 is mounted on a tip end of the outer tubular member 30.

The outer tubular member 30 and the inner tubular member 31 are arranged concentrically, and the outer tubular member 30 covers an outer periphery of the inner tubular member 31. As shown in FIG. 2, a tip-end side of the inner tubular member 31 is housed in the outer tubular member 30.

On the contrary, a base-end side of the inner tubular member 31 protrudes from a base-end side of the outer tubular member 30 as shown in FIG. 2.

An inside of the inner tubular member 31 functions as a first ventilation space 40. Further, there is a gap between the outer tubular member 30 and the inner tubular member 31, and the gap constitutes a second ventilation space 41.

The camera unit 32 is provided in the outer tubular member 30 and at a tip-end portion of the inner tubular member 31. There is a gap 42 between an inner surface of a tip-end opening portion of the inner tubular member 31 and the camera 36. Further, the camera 36 is installed on an extension of a center line of the inner tubular member 31.

The sealing glass (the transparent member) 33 is mounted on the tip end of the outer tubular member 30 via a sealing member 43 such as an O-ring. A tip-end side of the outer tubular member 30 is sealed by the sealing glass (the transparent member) 33 in a state of having airtightness.

A distance between the sealing glass (the transparent member) 33 and the camera unit 32 is a distance by which the light of the light-emission elements 50 is not incident on the camera 36 even when light of the light-emission elements 50 is reflected by a surface of the sealing glass (the transparent member) 33.

As shown in FIG. 2, the air-blowing unit 21 includes a small-sized air blower 48. In the air-blowing unit 21, the air blower 48 is attached to a support member 45. The air blower 48 is an axial-flow air blower including a propeller-shaped blade 46. The blade 46 is rotated by a motor 47.

As shown in FIG. 2, the air-blowing unit 21 is installed at the base-end side of the inner tubular member 31. A position of the blade 46 generally falls within a region of an opening circle of the inner tubular member 31 and does not protrude toward a second ventilation space 41 side.

As shown in FIG. 5, the cover member 22 is a quadrangular case in which one surface is opened and other five surfaces are covered by walls.

That is, the cover member 22 includes a front surface wall 60, an upper surface wall 61, a bottom surface wall 62, left and right side surface walls 63, 65. A back surface side of the cover member 22 is opened.

There is an intake opening 70 in the front surface wall 60 of the cover member 22. Exhaust openings 71 are formed in the upper surface wall 61 and the bottom surface wall 62 of the cover member 22, respectively.

Locking metal fittings 72 are provided on the left and right side surface walls 63, 65 of the cover member 22, respectively. The locking metal fitting 72 is a pulling-side member of a locking member including a toggle mechanism.

The tubular body portion 20 and the air-blowing unit 21 are fixed to the cover member 22 by screws or the like (not shown), and the tubular body portion 20, the air-blowing unit 21, and the cover member 22 are integrated to constitute the main body portion 25.

Next, the attachment member 23 will be described.

As shown in FIGS. 5 and 7, the attachment member 23 is configured with an attachment metal fitting 73 and a coupling member 75.

As shown in FIGS. 5 and 7, the attachment metal fitting 73 is a metal fitting having an approximate shape of a concave, and includes left and right side surface walls 77, 78 and a front surface wall 76 that faces the front surface wall 60 of the cover member 22.

A large opening 66 is provided in a center of the front surface wall 76.

Locking pieces 80 are provided on the left and right side surface walls 77, 78, respectively.

A coupling member 75 is a circular member provided with an opening 81, and similarly to the lid 102, an internal thread (an image-capturing-device-side engagement portion) 108 is formed on an inner surface.

The attachment member 23 is attached to the tubular member 105 where the through-hole 101 of the environment test apparatus 100 is formed.

Specifically, the opening 66 of the attachment metal fitting 73 is aligned with a protruding portion 107 of the tubular member 105 that protrudes from the environment test apparatus 100, and the coupling member 75 is engaged with an external thread 106 of the tubular member 105 from an outside of the protruding portion 107. That is, the internal thread 108 of the coupling member 75 is engaged with the external thread 106 of the tubular member 105, so that the coupling member 75 is attached to the protruding portion 107 of the tubular member 105, and the attachment metal fitting 73 is sandwiched between the coupling member 75 and the flange 110 of the tubular member 105.

Sealing members 82 and 83 such as an O-ring are interposed between the flange 110 and the attachment metal fitting 73 and between the attachment metal fitting 73 and the coupling member 75, respectively.

An attachment procedure of the image-capturing device 1 is as shown in FIGS. 6 to 8.

First, the attachment member 23 is attached to the tubular member 105 where the through-hole 101 of the environment test apparatus 100 is formed. That is, as shown in FIG. 6, the existing lid 102 is removed from the tubular member 105 of the environment test apparatus 100.

Subsequently, as shown in FIG. 7, the sealing member 82, the attachment metal fitting 73, the sealing member 83, and the coupling member 75 are sequentially mounted on the protruding portion 107 of the tubular member 105, and the coupling member 75 is fastened to the protruding portion 107 so as to fix the attachment metal fitting 73.

Accordingly, as shown in FIG. 8, the attachment metal fitting 73 is fixed to an outer end portion of the tubular member 105.

Thereafter, the main body portion 25 is attached to the attachment metal fitting 73. Specifically, the tubular body portion 20 of the main body portion 25 is inserted into the through-hole 101 of the environment test apparatus 100.

The tubular body portion 20 of the main body portion 25 is inserted into the opening 81 of the coupling member 75 and the opening 66 of the attachment metal fitting 73 to reach the through-hole 101 of the environment test apparatus 100. The outer tubular member 30 and the inner tubular member 31 of the tubular body portion 20 are both inserted into the opening 81 of the coupling member 75, the opening 66 of the attachment metal fitting 73, and the through-hole 101.

The main body portion 25 of the image-capturing device 1 is attached to the attachment metal fitting 73 such that a concave side of the cover member 22 and a concave side of the attachment metal fitting 73 face each other. Then, the locking metal fittings 72 provided on the side surface walls 63 and 65 of the cover member 22 are engaged with the locking pieces 80 of the attachment metal fitting 73, so that the main body portion 25 is integrated with the attachment member 23.

As a result, the image-capturing device 1 is attached to the environment test apparatus 100 in a state where the tubular body portion 20 is inserted into the through-hole 101.

FIG. 2 is a cross-sectional view schematically showing a state where the image-capturing device 1 is attached to the environment test apparatus 100.

In the main body portion 25 of the image-capturing device 1, the air-blowing unit 21 is outside the heat-insulation vessel. Most of the tubular body portion 20 is in the through-hole 101 that penetrates the heat-insulation wall 2, and a tip end thereof is at a position that faces the test chamber 3.

The test chamber 3 and an inside of the outer tubular member 30 of the main body portion 25 are partitioned by the sealing glass (the transparent member) 33, and an airtight state is maintained therebetween.

The light-incident portion 51 of the camera 36 in the main body portion 25 faces a test chamber 3 side. Further, the illumination member 38 also faces the test chamber 3 side.

Next, functions of the image-capturing device 1 will be described.

The environment test apparatus 100 of the present embodiment is used to perform an environment test, and an image of a state in the test chamber 3 during the environment test is captured by the image-capturing device 1.

That is, similar to the known environment test, an inside of the test chamber 3 is adjusted to a desired high-temperature environment or low-temperature environment, an article is placed therein, and the environment test is performed.

While an image is captured, the illumination member 38 of the image-capturing device 1 is turned on. The illumination member 38 faces the test chamber 3 side. An article in the test chamber 3 is illuminated by light emitted from the illumination member 38. Therefore, an image can be captured while illuminating the inside of the test chamber 3 or the like with illumination member 38.

Here, the camera unit 32 includes the hood member 37. The hood member 37 surrounds the light-incident portion 51 of the camera 36.

Accordingly, the light of the illumination member 38 is blocked by the hood member 37 and is not directly incident on the camera 36.

Further, the hood member 37 is sufficiently large with respect to the light-incident portion 51 of the camera 36 and a total length thereof is short. Accordingly, the hood member 37 does not enter a field of view of the camera 36, and the hood member 37 does not appear in an image.

Further, the illumination member 38 is disposed so as to surround an outside of the hood member 37 in a ring shape, and there is little concern that reflected light enters the light-incident portion 51. In addition, the illumination member 38 is unlikely to appear in the camera 36.

When the inside of the test chamber 3 is a high-temperature environment or a low-temperature environment, the motor 47 of the air-blowing unit 21 of the image-capturing device 1 is driven.

Outside air is sucked from the intake opening 70 of the cover member 22 by the air blower 48 of the air-blowing unit 21. The outside air passes through the first ventilation space 40 formed inside the inner tubular member 31 and is directly blown to the camera 36.

The tip end of the outer tubular member 30 of the main body portion 25 is sealed by the sealing glass (the transparent member) 33. Therefore, after passing through a region of the camera 36, blown air enters the second ventilation space 41 formed between the outer tubular member 30 and the inner tubular member 31 and returns to a base-end side of the tubular body portion 20. Then, the air is exhausted through the exhaust openings 71 of the cover member 22. That is, in the present embodiment, an inside of the image-capturing device 1 is divided into a forward side flow path that starts from the air blower 48 and reaches a surrounding space of the camera 36 via the first ventilation space 40 and the gap 42 in the inner tubular member 31, and a return side flow path that starts from the surrounding space of the camera 36 and reaches the exhaust openings 71 via the second ventilation space 41 formed between the outer tubular member 30 and the inner tubular member 31, so that staying of air is unlikely to occur.

Therefore, according to the image-capturing device 1 of the present embodiment, fresh air and air having a raised temperature after heat exchange are rarely mixed, and the fresh air can be blown to the camera 36. In this way, fresh outside air is always blown to the camera 36, and an ambient temperature of the camera 36 falls within a predetermined allowable range. The same applies to humidity. Humidity around the camera 36 is substantially the same as that of the outside air, and falls within a predetermined allowable range.

Therefore, it is unlikely that the camera 36 will malfunction. That is, the image-capturing device for the environment forming apparatus according to the present invention has few camera failures and can be used for a long period of time.

Further, when the inside of the test chamber 3 is adjusted to a low-temperature environment, a heater of the sealing glass (the transparent member) 33 is energized, and a surface temperature of the sealing glass (the transparent member) 33 is kept at a temperature higher than a temperature in the test chamber 3.

As a result, frost on an inner surface and an outer surface of the sealing glass (the transparent member) 33 is prevented. Further, a temperature of the sealing glass (the transparent member) 33 is increased, so that condensation or fogging can be prevented from occurring on the sealing glass (the transparent member) 33.

In the image-capturing device 1 of the present embodiment, the camera 36, the hood member 37, and the illumination member 38 constitute one camera unit 32.

Further, in the image-capturing device 1 of the present embodiment, an air-blowing unit 21 side is also configured as a unit.

Therefore, the image-capturing device of the present embodiment is highly compatible with components and can be applied to various environment test apparatuses.

That is, the through-hole 101 where the image-capturing device 1 is mounted may be a cable hole, and cable holes having the same inner diameter may be used in a plurality of environment test apparatuses.

Further, a length of the through-hole 101 may depend on a thickness of the heat-insulation wall 2, and may vary depending on a purpose, a capacity, a grade, or the like of the environment test apparatus.

In a case where diameters of cable holes are the same but thicknesses of heat-insulation walls are different, when a plurality of pipes that only differ in length are respectively prepared for the outer tubular member 30 and the inner tubular member 31, the pipes are selected according to a length of the through-hole 101 and the camera unit 32, the air-blowing unit 21 and the cover member 22 are combined, so that the image-capturing device 1 corresponding to each environment test apparatus 100 can be completed.

In the image-capturing device described above, the air-blowing unit 21 is attached to the base-end side of the inner tubular member 31, the first ventilation space 40 formed by the inner tubular member 31 is set as the forward side flow path, and air is blown toward the camera 36. The present invention is not limited to this configuration. The air-blowing unit 21 may be attached to a base-end side of the second ventilation space 41 formed between the outer tubular member 30 and the inner tubular member 31. According to this configuration, air passes through the second ventilation space 41 and is blown to the camera 36, and is exhausted through the first ventilation space 40 that is formed by the inner tubular member 31 and that is set as the return side flow path.

The air blower may be installed at a position away from the environment test apparatus 100, and the air blower and the first ventilation space 40 or the second ventilation space 41 may be connected by a duct or the like. Further, air blowing may be performed using an air-blowing device other than the air blower. For example, air compressed by a compressor may be supplied to the image-capturing device. When the inside of the test chamber 3 has a low temperature, dehumidified air may be supplied to the image-capturing device. It is also conceivable to supply air heated or cooled in advance to the image-capturing device to prevent condensation and the like.

In place of the air, other gases such as nitrogen may be supplied to the image-capturing device.

When a configuration in which gas is supplied from an outside is adopted, it is recommended to provide a port connected to the first ventilation space 40 or the second ventilation space 41. For example, the port may be provided in the cover member 22 or a port connected to the first ventilation space 40 or the second ventilation space 41 may be provided on a separate board, and the board may be fixed to the main body portion 25 of the image-capturing device or may be attached to a side surface of the environment test apparatus 100.

In the embodiment described above, although the image-capturing device 1 is attached to the environment test apparatus 100 by using the existing external thread (the main-body-side engagement portion) 106 provided on the protruding portion 107 of the tubular member 105, the image-capturing device 1 may be attached by other methods.

For example, a fastening element such as a bolt may be used to attach the image-capturing device directly to the side surface of the environment test apparatus 100.

Further, the image-capturing device may be attached to the side surface of the environment test apparatus 100 by an adhesive or a magnet.

Although the environment test apparatus has been described as an example in the embodiment described above, an object of the present invention is not limited to the environment test apparatus, and the present invention can be widely used for an apparatus that performs a heating processing such as an oven and an environment forming apparatus such as a storage warehouse having an air conditioning function.

In the embodiment described above, although the image-capturing device 1 is mounted in the cable hole, other through-holes may be utilized. For example, the image-capturing device 1 may be mounted in a through-hole through which a rod, an arm, or the like for applying an external force to an article in the test chamber 3 is inserted, a through-hole for connecting an air-conditioning apparatus installed outside to the test chamber 3 with a duct, or a through-hole for inserting a sensor.

The embodiment described above provides an image-capturing device for an environment forming apparatus used for the environment forming apparatus. The environment forming apparatus includes: an environment forming chamber configured to be adjusted to a predetermined environment; and a through-hole configured to connect the environment forming chamber to an outside, in which the environment forming apparatus includes a main-body-side engagement portion. The image-capturing device for the environment forming apparatus includes: a camera; a camera holding member configured to hold the camera; and a coupling member, in which the coupling member includes an opening and the image-capturing-device-side engagement portion, the image-capturing-device-side engagement portion is configured to be engaged with the main-body-side engagement portion, and the camera is fixable to the environment forming apparatus by engaging the image-capturing-device-side engagement portion with the main-body-side engagement portion in a state where the camera is inserted into the through-hole.

What is claimed is:

1. An image-capturing device for an environment forming apparatus used for the environment forming apparatus, wherein the environment forming apparatus includes an environment forming chamber configured to be adjusted to a predetermined environment, and a through-hole configured to connect the environment forming chamber to an outside, the image-capturing device for the environment forming apparatus comprising:
a camera;
an inner tubular member;
an outer tubular member configured to cover the inner tubular member; and
an air blower,
wherein a first ventilation space is formed by an inside of the inner tubular member, and a second ventilation space is formed between the inner tubular member and the outer tubular member, and
wherein air is blown toward the camera by the air blower via one of the first ventilation space and the second ventilation space, and is exhausted via the other of the first ventilation space and the second ventilation space.

2. An image-capturing device for an environment forming apparatus used for the environment forming apparatus, wherein the environment forming apparatus includes an environment forming chamber configured to be adjusted to a predetermined environment, and a through-hole configured to connect the environment forming chamber to an outside, the image-capturing device for the environment forming apparatus comprising:
a camera;
an inner tubular member;
an outer tubular member configured to cover the inner tubular member; and
an air blower,
wherein a first ventilation space is formed by an inside of the inner tubular member, and a second ventilation space is formed between the inner tubular member and the outer tubular member, and
wherein the camera is at a position on a tip-end side of the first ventilation space or the second ventilation space, and the air blower is at a position on a base-end side of the first ventilation space or the second ventilation space.

3. An image-capturing device for an environment forming apparatus used for the environment forming apparatus, wherein the environment forming apparatus includes an environment forming chamber configured to be adjusted to a predetermined environment, and a through-hole configured to connect the environment forming chamber to an outside, the image-capturing device for the environment forming apparatus comprising:
a camera;
an inner tubular member; and
an outer tubular member configured to cover the inner tubular member,
wherein a first ventilation space is formed by an inside of the inner tubular member, and a second ventilation space is formed between the inner tubular member and the outer tubular member, and
wherein air is blown toward the camera via one of the first ventilation space and the second ventilation space, and is exhausted via the other of the first ventilation space and the second ventilation space.

4. The image-capturing device for the environment forming apparatus according to claim 1,
wherein a transparent member is mounted on a tip-end portion of the outer tubular member and the transparent member has a temperature-raising function.

5. The image-capturing device for the environment forming apparatus according to claim 2,
wherein a transparent member is mounted on a tip-end portion of the outer tubular member and the transparent member has a temperature-raising function.

6. The image-capturing device for the environment forming apparatus according to claim 3,
wherein a transparent member is mounted on a tip-end portion of the outer tubular member and the transparent member has a temperature-raising function.

7. The image-capturing device for the environment forming apparatus according to claim 1,
wherein illumination is provided at a tip-end portion of the outer tubular member or in a vicinity of the tip-end portion.

8. The image-capturing device for the environment forming apparatus according to claim 2,
wherein illumination is provided at a tip-end portion of the outer tubular member or in a vicinity of the tip-end portion.

9. The image-capturing device for the environment forming apparatus according to claim 3,
wherein illumination is provided at a tip-end portion of the outer tubular member or in a vicinity of the tip-end portion.

10. The image-capturing device for the environment forming apparatus according to claim 7,
wherein the illumination is installed in a ring shape with respect to a light-incident portion of the camera.

11. The image-capturing device for the environment forming apparatus according to claim 8,
wherein the illumination is installed in a ring shape with respect to a light-incident portion of the camera.

12. The image-capturing device for the environment forming apparatus according to claim 9,
wherein the illumination is installed in a ring shape with respect to a light-incident portion of the camera.

13. The image-capturing device for the environment forming apparatus according to claim 1,
wherein the environment forming apparatus includes a main-body-side engagement portion,
wherein the image-capturing device for the environment forming apparatus includes a coupling member, and the coupling member includes an opening and an image-capturing-device-side engagement portion, and
wherein the image-capturing-device-side engagement portion is configured to be engaged with the main-body-side engagement portion, and the outer tubular member and the inner tubular member are inserted into the opening.

14. The image-capturing device for the environment forming apparatus according to claim 2,
wherein the environment forming apparatus includes a main-body-side engagement portion,
wherein the image-capturing device for the environment forming apparatus includes a coupling member, and the coupling member includes an opening and an image-capturing-device-side engagement portion, and
wherein the image-capturing-device-side engagement portion is configured to be engaged with the main-body-side engagement portion, and the outer tubular member and the inner tubular member are inserted into the opening.

15. The image-capturing device for the environment forming apparatus according to claim 3,
wherein the environment forming apparatus includes a main-body-side engagement portion,
wherein the image-capturing device for the environment forming apparatus includes a coupling member, and the coupling member includes an opening and an image-capturing-device-side engagement portion, and
wherein the image-capturing-device-side engagement portion is configured to be engaged with the main-body-side engagement portion, and the outer tubular member and the inner tubular member are inserted into the opening.

16. An environment forming apparatus comprising:
an environment forming chamber configured to be adjusted to a predetermined environment; and
a through-hole configured to connect the environment forming chamber to an outside,
wherein the image-capturing device for the environment forming apparatus according to claim 1 is mounted in the through-hole.

17. An environment forming apparatus comprising:
an environment forming chamber configured to be adjusted to a predetermined environment; and
a through-hole configured to connect the environment forming chamber to an outside,
wherein the image-capturing device for the environment forming apparatus according to claim 2 is mounted in the through-hole.

18. An environment forming apparatus comprising:
an environment forming chamber configured to be adjusted to a predetermined environment; and
a through-hole configured to connect the environment forming chamber to an outside,
wherein the image-capturing device for the environment forming apparatus according to claim 3 is mounted in the through-hole.
